(19) United States
(12) Patent Application Publication
(10) Pub. No.: US 2026/0162443 A1
(43) Pub. Date: Jun. 11, 2026

(54) PARKING AREA DETERMINATION DEVICE, VEHICLE CONTROL DEVICE, PARKING AREA DETERMINATION METHOD, AND PROGRAM

(71) Applicant: TOYOTA JIDOSHA KABUSHIKI KAISHA, Toyota-shi (JP)

(72) Inventors: Masaki IKAI, Toyota-shi (JP); Masashi OISHI, Owariasahi-shi (JP); Ryo ISHII, Toyota-shi (JP); Takuya KAMINADE, Okazaki-shi (JP)

(73) Assignee: TOYOTA JIDOSHA KABUSHIKI KAISHA, Toyota-shi (JP)

(21) Appl. No.: 19/407,226

(22) Filed: Dec. 3, 2025

(30) Foreign Application Priority Data
Dec. 10, 2024 (JP) 2024-215479

(51) Int. Cl. G06V 20/58; B60W 50/12

(52) U.S. Cl. CPC G06V 20/586; B60W 50/12; B60W 2420/403; B60W 2520/10; B60W 2540/106

(57) ABSTRACT

To recognize whether a vehicle is located within a parking area even when an imaging device is not activated, a parking area determination device is provided. The device includes an acquisition unit configured to detect, based on image data acquired by the imaging device that captures surroundings of a vehicle, parking spaces and/or parked vehicles, and to acquire parking rows in which the detected parking spaces and/or parked vehicles are adjacent in a predetermined direction and appear continuously in at least a predetermined number. A determination unit determines whether the vehicle is located within a parking area. After determining that the vehicle is in the parking area, when a start switch is turned off and then turned on while the imaging device is not yet activated, the unit determines the vehicle remains in the parking area while a travel distance and vehicle speed are below respective thresholds.

### CROSS-REFERENCE TO RELATED APPLICATION

This application claims priority to Japanese Patent Application No. JP 2024-215479 filed on Dec. 10, 2024, the content of which is hereby incorporated by reference in its entirety into this application.

### BACKGROUND OF THE INVENTION

### 1. Field of the Invention

The present disclosure relates to a parking area determination device, a vehicle control device, a parking area determination method, and a program.

### 2. Description of the Related Art

For example, Japanese Patent Application Laid-Open (kokai) No. 2023-154553 discloses a device that recognizes a group of parking spaces as a “parking row” when a predetermined number or more of parking spaces and/or parked vehicles obtained from surrounding image data captured by an on-board camera are continuously detected. Based on the recognized parking row, the device determines whether the host vehicle is present within a parking area that includes the parking row.

### SUMMARY OF THE INVENTION

When the host vehicle enters a parking space within a parking area, the parking space and parked vehicles may fall within the field of view of an on-board camera. Therefore, it is possible to determine whether the vehicle is located within a parking area based on image data, as in the technique described in above Patent Document. However, when the host vehicle has already entered a parking space, and the start switch (ignition switch or power switch) has been turned off, in a case where the start switch is subsequently turned on again for departure, the on-board camera remains inactive for a certain period of time after the start switch is turned on. Accordingly, during departure, it is impossible to perform a parking-area determination based on image data until the on-board camera becomes active. Furthermore, even after the on-board camera has been activated, if the vehicle remains stationary, the parking space in which the vehicle is parked or the surrounding parking spaces may not fall within the camera's field of view, making it potentially impossible to perform the parking-area determination.

One of the objectives of the present disclosure is to enable effective recognition of whether the host vehicle is located within a parking area even when the on-board imaging device is inactive, in cases where the start switch is turned on after having been turned off within the parking area.

A device according to at least one embodiment of the present disclosure is a parking area determination device comprising:
a parking row acquisition unit configured to detect, based on image data acquired by an in-vehicle imaging device that captures surroundings of a vehicle, parking spaces and/or parked vehicles around the vehicle, and to acquire parking rows in which the detected parking spaces and/or parked vehicles are adjacent to each other in a predetermined direction and appear continuously in a number equal to or greater than a predetermined threshold; and
a parking area determination unit configured to determine whether the vehicle is located within a parking area having the parking rows,
wherein the parking area determination unit:
after determining that the vehicle is located within the parking area, when a first condition is satisfied in which a start switch of the vehicle is turned off, and when a second condition is satisfied in which, upon the start switch being turned on, the in-vehicle imaging device has not yet been activated,
determines that the vehicle is located within the parking area while specific conditions are satisfied in which a travel distance of the vehicle from establishment of the second condition is less than a predetermined first threshold, and a vehicle speed is less than a predetermined second threshold,
and determines that the vehicle is not located within the parking area when the specific conditions are no longer satisfied.

### BRIEF DESCRIPTION OF THE DRAWINGS

FIG. 1 is a schematic diagram illustrating the hardware and software configuration of a vehicle according to the present embodiment.

FIG. 2 is a schematic top view illustrating parking space demarcation lines and parked vehicles within a parking area.

FIG. 3A is a schematic diagram for explaining the determination of a parking row according to the present embodiment.

FIG. 3B is a schematic diagram for explaining the determination of a parking row according to the present embodiment.

FIG. 3C is a schematic diagram for explaining the determination of a parking row according to the present embodiment.

FIG. 4A is a schematic diagram of the present embodiment for explaining the comparison between the present embodiment and a comparative example.

FIG. 4B is a schematic diagram of the comparative example for explaining the comparison between the present embodiment and the comparative example.

FIG. 5 is a flowchart illustrating a routine of a parking area determination process according to the present embodiment.

FIG. 6 is a flowchart illustrating another routine of the parking area determination process according to the present embodiment.

FIG. 7 is a flowchart illustrating a routine of an erroneous accelerator operation determination and drive force suppression control according to the present embodiment.

FIG. 8 is a schematic diagram for explaining a first modification example.

FIG. 9 is a schematic diagram for explaining a second modification example.

### DESCRIPTION OF THE EMBODIMENTS

Hereinafter, with reference to the drawings, a parking area determination device, a vehicle control device, a parking area determination method, and a program according to the present embodiment will be described.

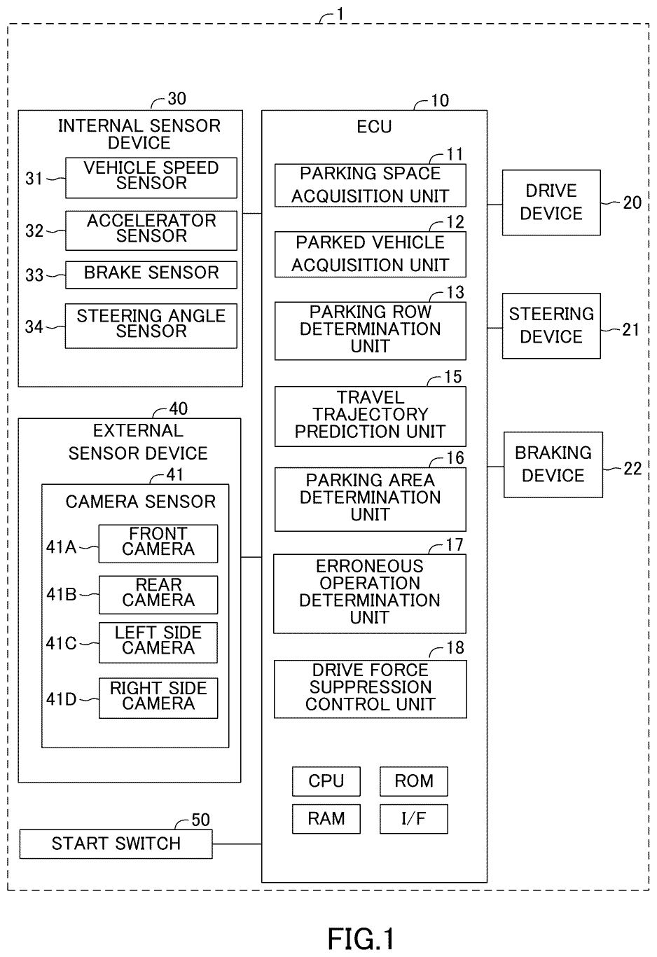

FIG. 1 is a schematic diagram illustrating a hardware configuration of a vehicle 1 according to the present embodiment. In the following description, the vehicle 1 may also be referred to as the host vehicle when it is necessary to distinguish it from other vehicles.

The vehicle 1 includes an ECU (Electronic Control Unit) 10. The ECU 10 comprises a CPU (Central Processing Unit), ROM (Read Only Memory), RAM (Random Access Memory), and an interface device, among others. The CPU is a processor that executes various programs stored in the ROM. The ROM is a non-volatile memory that stores data and various programs necessary for the CPU to perform processing. The RAM is a volatile memory that provides a working area for program execution by the CPU. The interface device is a communication device for exchanging information with external devices.

The ECU 10 serves as a central control unit that provides driving assistance for the driver, including autonomous driving functions. The ECU 10 is communicably connected to a drive device 20, a steering device 21, a braking device 22, an internal sensor device 30, an external sensor device 40, and a start switch 50, among others.

A drive device 20 generates drive force to be transmitted to the drive wheels of the vehicle 1. Examples of the drive device 20 include an electric motor and an engine. A steering device 21 applies a steering force to the wheels of the vehicle 1. A braking device 22 applies a braking force to the wheels of the vehicle 1.

An internal sensor device 30 is a group of sensors that acquire information on the state of the vehicle 1. Specifically, the internal sensor device 30 includes a vehicle speed sensor 31, an accelerator sensor 32, a brake sensor 33, and a steering angle sensor 34, among others.

The vehicle speed sensor 31 detects the traveling speed (vehicle speed V) of the vehicle 1. The accelerator sensor 32 detects the operation amount of an accelerator pedal (acceleration operator, not shown) operated by the driver. The brake sensor 33 detects the operation amount of a brake pedal (not shown) operated by the driver. The steering angle sensor 34 detects a steering angle of a steering wheel (or a steering shaft, not shown). The internal sensor device 30 transmits the state information of the vehicle 1, detected by each of the sensors 31 to 34, to the ECU 10 at predetermined intervals.

An external sensor device 40 is a group of sensors that acquire information (target information) about objects surrounding the vehicle 1. Specifically, the external sensor device 40 includes a camera sensor 41. Examples of such target information include surrounding vehicles, surrounding structures, intersections, traffic lights, road signs, parking space demarcation lines, lane markings, stop lines, and temporary stop lines. The target information around the vehicle 1 obtained by the external sensor device 40 is transmitted to the ECU 10.

The camera sensor 41 is an example of an in-vehicle imaging device according to the present disclosure. It captures images of the surroundings of the vehicle 1 and processes the captured image data to obtain surrounding images. The camera sensor 41 may be, for example, a stereo camera or a monocular camera that employs an imaging element such as a CMOS or CCD digital camera. In the present embodiment, the camera sensor 41 includes a front camera 41A for capturing a front region of the vehicle 1, a rear camera 41B for capturing a rear region, a left-side camera 41C for capturing a left-side region, and a right-side camera 41D for capturing a right-side region. Hereinafter, these cameras 41A to 41D are collectively referred to simply as the “camera sensor 41,” and the image data captured by each of the cameras 41A to 41D are collectively referred to as “image data.”

A start switch 50 is an ON/OFF switch operated by the driver to activate a vehicle system (such as the ECU 10), and is also referred to as an ignition switch or a power switch. When the vehicle system is in a stopped state (i.e., the start switch 50 is in the OFF state) and the driver turns on the start switch 50, the vehicle system is activated. Conversely, when the vehicle system is in an activated state (i.e., the start switch 50 is ON) and the vehicle 1 is stationary, if the driver turns off the start switch 50, the vehicle system is stopped.

Next, the software configuration of the ECU 10 will be described. The ECU 10 includes, as part of its functional elements, a parking space acquisition unit 11, a parked vehicle acquisition unit 12, a parking row determination unit 13, a travel trajectory prediction unit 15, a parking area determination unit 16, an erroneous operation determination unit 17, and a drive force suppression control unit 18. These functional elements are described as being included in the integrated hardware of the ECU 10. However, some of these elements may alternatively be provided in a separate ECU distinct from the ECU 10. Furthermore, all or part of the functional elements of the ECU 10 may be provided in an information processing device of a facility (for example, a management center or the like) that is capable of communicating with the vehicle 1.

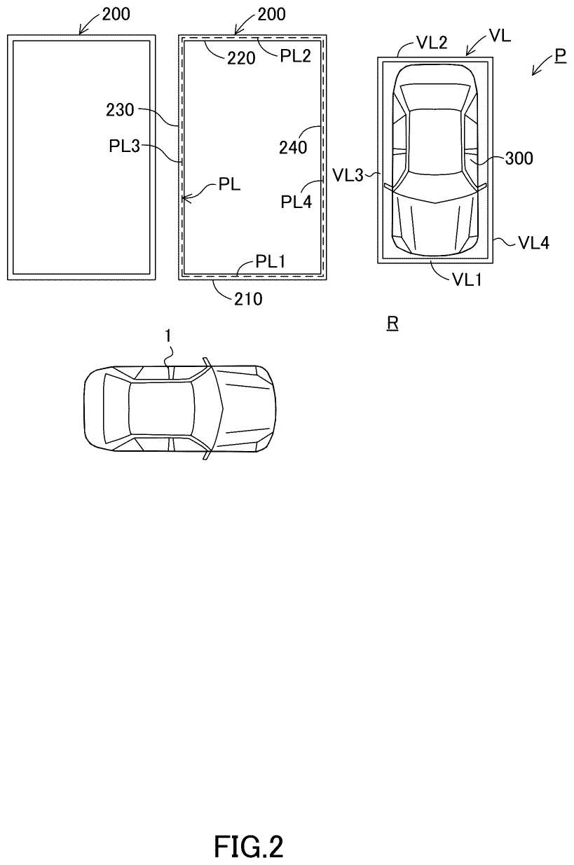

The parking space acquisition unit 11 acquires parking spaces within a parking area based on image data of the surroundings of the vehicle 1 captured by the camera sensor 41. FIG. 2 is a schematic diagram illustrating an example of parking demarcation lines 200 drawn on the surface of a parking area P. In FIG. 2, reference numeral 300 denotes a parked vehicle in the parking area P, and reference symbol R denotes a lane R through which the host vehicle 1 travels after entering the parking area P. The parking space acquisition unit 11 performs image analysis processing such as edge extraction, pattern matching, or feature point extraction on the image data captured by the camera sensor 41 to extract the parking demarcation lines 200 from the image data. Based on the extracted parking demarcation lines 200, the parking space acquisition unit 11 acquires parking spaces PL. Here, the parking demarcation lines 200 refer to white lines or the like drawn on the surface of the parking area P for demarcating a parking space PL for one vehicle. Whether the extracted parking demarcation lines 200 correspond to a parking space PL can be determined, for example, by comparing the dimensions of the region defined by the parking demarcation lines 200 with standard dimensions (width and depth) of parking spaces in general public parking areas.

In the example shown in FIG. 2, the parking demarcation lines 200 are drawn on the road surface as substantially rectangular solid-line frames. In this case, the parking space acquisition unit 11 extracts, from a pair of parking demarcation lines 210 and 220 that extend substantially parallel to the extending direction of the lane R, the parking demarcation line 210 located on the side of the lane R as a front boundary line PL1, and the parking demarcation line 220 located farther from the lane R than the line 210 as a rear boundary line PL2. Furthermore, among a pair of parking demarcation lines 230 and 240 that intersect the parking demarcation lines 210 and 220 at substantially right angles, the parking space acquisition unit 11 extracts the parking demarcation line 230, which is positioned on the left side as viewed from the lane R side, as a left boundary line PL3, and the parking demarcation line 240 positioned on the right side as a right boundary line PL4.

The parking space acquisition unit 11 acquires positional information of the extracted boundary lines PL1 to PL4 with respect to the host vehicle 1 (for example, coordinates in an xy-plane coordinate system in which the position of the vehicle 1 serves as the origin). The parking space acquisition unit 11 then transmits the positional information of the extracted boundary lines PL1 to PL4 to the parking row determination unit 13 at predetermined intervals. It should be noted that the types of parking demarcation lines 200 drawn on the road surface of the parking area P are not limited to the example shown in FIG. 2. They may, for instance, be two parallel straight lines. In the case of two parallel straight lines, the parking space acquisition unit 11 may extract virtual demarcation lines connecting the ends of the parallel lines as the front boundary line PL1 and the rear boundary line PL2. Moreover, the parking demarcation lines 200 are not limited to solid lines and may instead be dashed lines, or a combination of solid and dashed lines, or any other form of demarcation lines.

The parked vehicle acquisition unit 12 acquires a vehicle contour line (hereinafter referred to as a parked vehicle contour line) that represents the boundary between a parked vehicle 300 and the road surface, based on image data of the surroundings of the vehicle 1 captured by the camera sensor 41. In FIG. 2, reference symbol VL denotes the parked vehicle contour line. Although the actual parked vehicle contour line VL has a complex shape including components such as side mirrors, in the following description, the parked vehicle contour line VL is represented as a minimum rectangular frame line enclosing the outer periphery of the vehicle body of the parked vehicle 300.

The parked vehicle acquisition unit 12 first performs image analysis processing such as edge extraction, pattern matching, or feature point extraction on the image data captured by the camera sensor 41, to determine whether a parked vehicle 300 is included in the image data. When the parked vehicle acquisition unit 12 determines that a parked vehicle 300 is present in the image data, it identifies the minimum rectangular frame line enclosing the parked vehicle 300 within the image data, and extracts the identified rectangular frame line as the parked vehicle contour line VL. Among the identified frame lines, the parked vehicle acquisition unit 12 extracts the portion corresponding to the front end of the parked vehicle 300 as a front contour line VL1, the portion corresponding to the rear end as a rear contour line VL2, the portion corresponding to the left end as a left contour line VL3, and the portion corresponding to the right end as a right contour line VL4. The parked vehicle acquisition unit 12 acquires positional information of each extracted contour line VL1 to VL4 with respect to the host vehicle 1 (for example, coordinates in an xy-plane coordinate system in which the position of the vehicle 1 serves as the origin). The unit then transmits the acquired positional information to the parking row determination unit 13 at predetermined intervals.

The parking row determination unit 13 determines whether the parking spaces PL and the parked vehicle contour lines VL form a continuous parking row, based on the positional information of the parking spaces PL transmitted from the parking space acquisition unit 11 and the positional information of the parked vehicle contour lines VL transmitted from the parked vehicle acquisition unit 12. In the following description, the longitudinal direction of the parking space PL and the parked vehicle contour line VL is defined as the vertical direction, and the direction substantially perpendicular to the longitudinal direction is defined as the lateral direction. Although examples in which the parking spaces PL and the parked vehicle contour lines VL are adjacent in the lateral direction are described below, the same processing applies when they are adjacent in the vertical direction, and therefore, the explanation of that case is omitted.

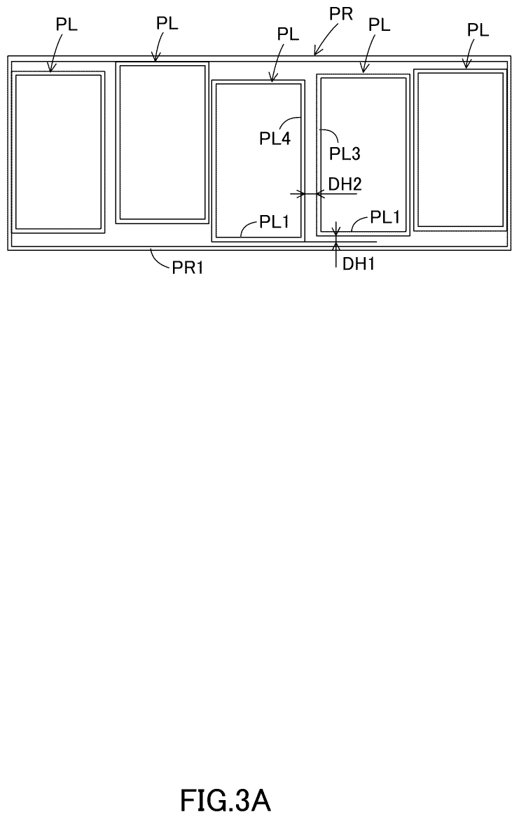

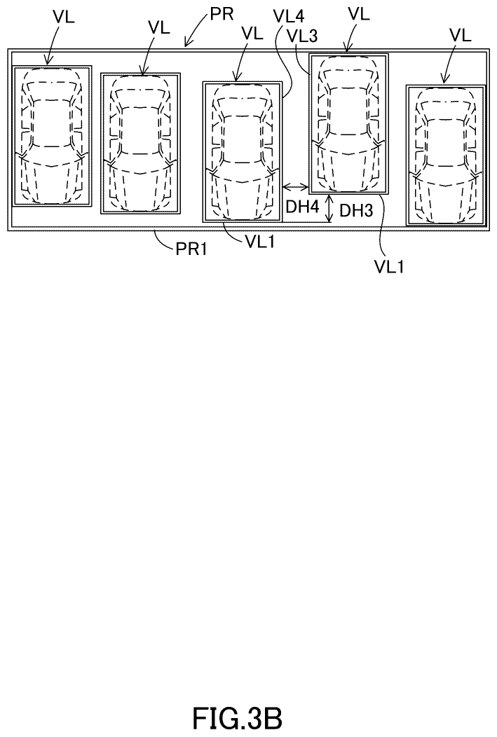

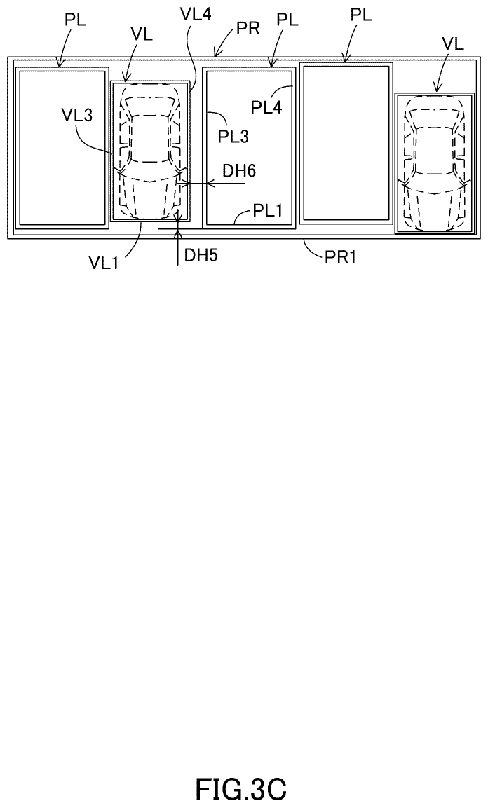

As shown in FIG. 3A, when adjacent parking spaces PL are obtained from the image data, the parking row determination unit 13 calculates a vertical separation distance DH1 between the front boundary lines PL1 of the adjacent parking spaces PL, and determines whether the separation distance DH1 satisfies a first condition that the distance is equal to or less than a predetermined first threshold value. The first condition may alternatively be determined based on the separation distance between the rear boundary lines PL2. The parking row determination unit 13 also calculates a lateral separation distance DH2 between the left and right boundary lines PL3 and PL4 of the adjacent parking spaces PL, and determines whether the separation distance DH2 satisfies a second condition that the distance is equal to or less than a predetermined second threshold value. The first threshold value and the second threshold value are not particularly limited but may be set based on standard dimensions of parking spaces in general public parking areas. When both the first and second conditions are satisfied, the parking row determination unit 13 regards the adjacent parking spaces PL as laterally continuous.

As shown in FIG. 3B, when adjacent parked vehicle contour lines VL are obtained from the image data, the parking row determination unit 13 calculates a vertical separation distance DH3 between the front contour lines VL1 of the adjacent parked vehicle contour lines VL, and determines whether the separation distance DH3 satisfies a third condition that the distance is equal to or less than a predetermined third threshold value. The third condition may alternatively be determined based on the separation distance between the rear contour lines VL2. The parking row determination unit 13 also calculates a lateral separation distance DH4 between the left and right contour lines VL3 and VL4 of the adjacent parked vehicle contour lines VL, and determines whether the separation distance DH4 satisfies a fourth condition that the distance is equal to or less than a predetermined fourth threshold value. The third and fourth threshold values are not particularly limited; however, it is preferable that at least the fourth threshold value be set larger than the second threshold value described above. When both the third and fourth conditions are satisfied, the parking row determination unit 13 regards the adjacent parked vehicle contour lines VL as laterally continuous.

As shown in FIG. 3C, when both parking spaces PL and parked vehicle contour lines VL are obtained from the image data, the parking row determination unit 13 calculates a vertical separation distance DH5 between the front boundary line PL1 of the parking space PL and the front contour line VL1 of the parked vehicle VL, and determines whether the separation distance DH5 satisfies a fifth condition that the distance is equal to or less than a predetermined fifth threshold value. The fifth condition may alternatively be determined based on the separation distance between the rear boundary line PL2 and the rear contour line VL2. The parking row determination unit 13 also calculates a lateral separation distance DH6 between the left and right boundary lines PL3 and PL4 of the parking space PL and the left and right contour lines VL3 and VL4 of the parked vehicle VL, and determines whether the separation distance DH6 satisfies a sixth condition that the distance is equal to or less than a predetermined sixth threshold value. The fifth and sixth threshold values are not particularly limited; however, it is preferable that at least the sixth threshold value be set larger than the second threshold value described above and smaller than the fourth threshold value described above. When both the fifth and sixth conditions are satisfied, the parking row determination unit 13 regards the adjacent parking space PL and the parked vehicle contour line VL as laterally continuous.

The parking row determination unit 13 determines that a parking row PR is formed when the number of consecutive parking spaces PL, the number of consecutive parked vehicle contour lines VL, or the number of consecutive parking spaces PL and parked vehicle contour lines VL in any order, is equal to or greater than a predetermined threshold number (for example, three to five). By determining that a group of consecutive parking spaces PL and/or parked vehicle contour lines VL constitutes a parking row PR when the count exceeds the threshold number, it is possible to effectively prevent misrecognition of road markings such as stop lines or pedestrian crossings, or other vehicles temporarily stopped around the vehicle 1 due to traffic signals or the like, as the parking row PR.

The parking row determination unit 13 extracts, from the image data, a rectangular frame defining the parking row PR, and acquires positional information (for example, coordinates in an xy-plane coordinate system in which the position of the vehicle 1 serves as the origin) of each straight line PR1 to PR4 forming the extracted rectangular frame. The parking row determination unit 13 transmits the positional information of each straight line PR1 to PR4 to the parking area determination unit 16 at predetermined intervals. In the following description, the straight line PR1 of the rectangular frame (parking row PR) that faces the lane R is referred to as the front parking row line.

The travel trajectory prediction unit 15 calculates a predicted travel trajectory of the vehicle 1 based on the traveling state of the vehicle 1 obtained by the internal sensor device 30. Here, the predicted travel trajectory refers to a trajectory that the vehicle 1 is expected to follow if its current traveling state is maintained. The predicted travel trajectory may be calculated, for example, based on the vehicle speed V acquired by the vehicle speed sensor 31 and the steering angle acquired by the steering angle sensor 34. The travel trajectory prediction unit 15 transmits the calculated predicted travel trajectory to the parking area determination unit 16 at predetermined intervals.

The parking area determination unit 16 determines whether the vehicle 1 is located within the parking area P, based on the positional information of the parking row PR relative to the vehicle 1 transmitted from the parking row determination unit 13, and the predicted travel trajectory of the vehicle 1 transmitted from the travel trajectory prediction unit 15. First, the parking area determination unit 16 determines whether the predicted travel trajectory of the vehicle 1, represented in a plane coordinate system, intersects the front parking row line PR1 of the parking row PR. If it is determined that an intersection occurs, the parking area determination unit 16 calculates an estimated arrival time TA, which represents the time required for the vehicle 1 to reach the intersection point between the predicted travel trajectory and the front parking row line PR1 from its current position. The estimated arrival time TA may be obtained, for example, by dividing a distance D along the predicted travel trajectory from the current position of the vehicle 1 to the intersection point by the current vehicle speed V (TA=D/V). If the estimated arrival time TA is equal to or less than a predetermined time (for example, several seconds), the parking area determination unit 16 determines that the vehicle 1 is located within the parking area P. Conversely, if the estimated arrival time TA exceeds the predetermined time, the parking area determination unit 16 determines that the vehicle 1 is not located within the parking area P.

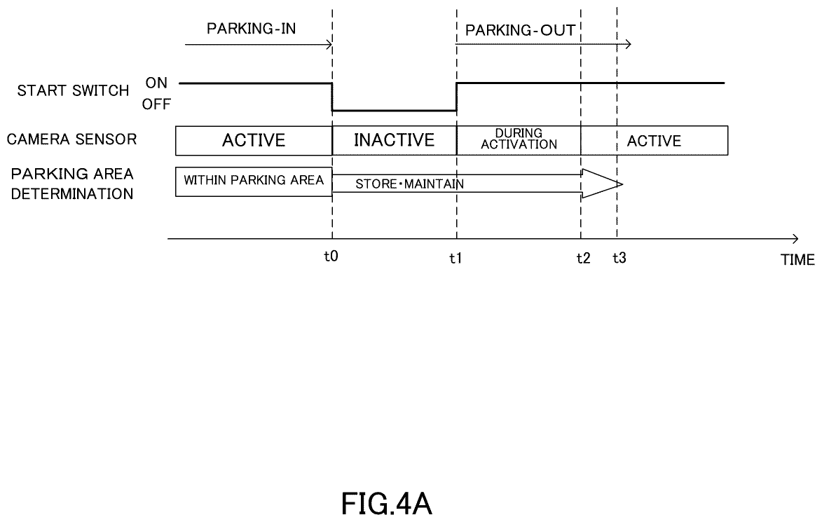

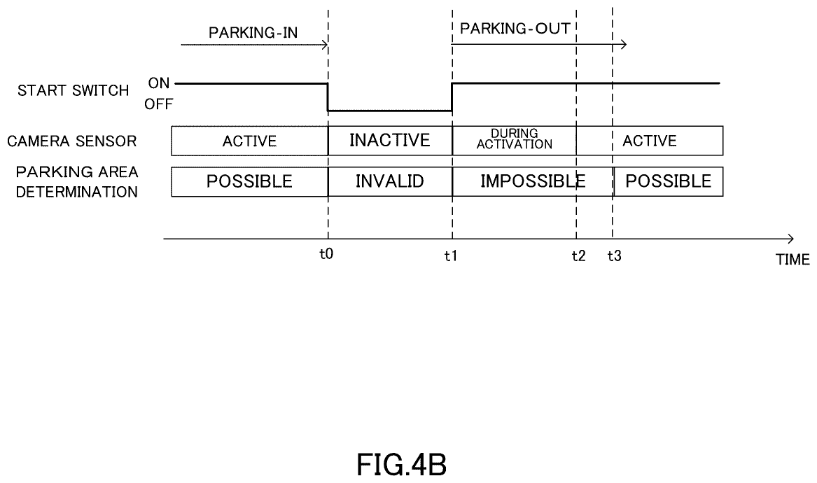

When the vehicle 1 has entered a predetermined parking space PL and the driver turns off the start switch 50, and thereafter turns on the start switch 50 to depart, a certain period of time is required before the camera sensor 41 is activated and becomes fully operational (see FIG. 4B, time period t1 to t2). Accordingly, during the period before the camera sensor 41 becomes active, it is not possible to acquire the surrounding parking spaces PL or parked vehicle contour lines VL of the vehicle 1 based on the detection results of the camera sensor 41. Even after the camera sensor 41 is activated, if the vehicle 1 remains stationary, it is possible that neither the parking space PL in which the vehicle 1 is parked nor the surrounding parking spaces PL are included within the field of view of the camera sensor 41 (see FIG. 4B, time period t2 to t3). That is, as shown in FIG. 4B, until a predetermined period t₁-t₃ has elapsed after the start switch 50 is turned on, it may not be possible to perform parking area determination based on the detection results of the camera sensor 41. If, for example, the image data of the surroundings acquired by the camera sensor 41 during parking were to be stored even after the start switch 50 is turned off, it would result in consumption of a large amount of memory capacity.

When the parking area determination unit 16 determines that the vehicle 1 is located within the parking area P, and a first condition is satisfied in which the start switch 50 is turned off, the parking area determination unit 16 stores, in a memory unit (for example, RAM) of the ECU 10, the determination result indicating that the vehicle 1 is located within the parking area P, even after the start switch 50 is turned off. After storing the determination result that the vehicle 1 is located within the parking area P, when the start switch 50 is turned on again and a second condition is satisfied in which the camera sensor 41 has not yet been activated, the parking area determination unit 16 maintains (i.e., continues to regard the vehicle 1 as being located within the parking area P) the previous determination result while both of the following specific conditions (1) and (2) are satisfied:
Specific condition (1): The travel distance of the vehicle 1 since the second condition was satisfied is less than a predetermined first threshold value.
Specific condition (2): The vehicle speed V of the vehicle 1 since the second condition was satisfied is less than a predetermined second threshold value.

The first threshold value is not particularly limited, but may be set based on the typical size of a parking area, for example, as an average distance (such as several to several tens of meters) that the vehicle 1 travels from the parking position to the exit of the parking area. The second threshold value is also not particularly limited, but may be set based on a lower limit of vehicle speed at which a vehicle would not normally travel within a parking area (for example, approximately 20 km/h). Thus, after the determination result indicating that the vehicle 1 is located within the parking area P has been stored, when the start switch 50 is turned on, the parking area determination unit 16 maintains the determination result that the vehicle 1 is located within the parking area P while both specific conditions (1) and (2) are satisfied. Accordingly, even during the period in which the camera sensor 41 is not yet operational (see FIG. 4A, time period t1 to t2), and during the period after activation of the camera sensor 41 when the vehicle 1 may still be stationary (see FIG. 4A, time period t2 to t3), it becomes possible to appropriately recognize whether the vehicle 1 is located within the parking area P.

After the second condition is satisfied, when at least one of the specific conditions (1) or (2) is no longer satisfied, the parking area determination unit 16 determines that the vehicle 1 is not located within the parking area P, that is, that the vehicle 1 is located outside the parking area P.

The erroneous operation determination unit 17 determines whether the driver of the vehicle 1 has performed an erroneous accelerator operation, that is, an unintended depression of the accelerator pedal. Specifically, the erroneous operation determination unit 17 determines that an erroneous accelerator operation has been performed when all of the following first to fifth determination conditions are satisfied:
First determination condition: The vehicle speed V is less than a predetermined vehicle speed threshold value V_{Min}.
Second determination condition: The accelerator pedal operation amount (accelerator operation amount) AP is equal to or greater than a predetermined operation amount threshold value AP_{Max}.
Third determination condition: The accelerator pedal operation speed APV is equal to or greater than a predetermined operation speed threshold value APV_{Max}.
Fourth determination condition: No brake operation is being performed.
Fifth determination condition: The turn signal indicator is not being operated.

When all of the first to fifth determination conditions are satisfied, the erroneous operation determination unit 17 determines that the driver has performed an erroneous accelerator operation. Conversely, when at least one of the first to fifth determination conditions is not satisfied, the erroneous operation determination unit 17 determines that the driver has not performed an erroneous accelerator operation. It should be noted that one or more of the above determination conditions may be omitted, or additional conditions may be added, for determining an erroneous accelerator operation.

The drive force suppression control unit 18 executes drive force suppression control when both of the following conditions are satisfied:
(1) the parking area determination unit 16 determines that the vehicle 1 is located within the parking area P, and
(2) the erroneous operation determination unit 17 determines that the driver has performed an erroneous accelerator operation.

In the drive force suppression control, the drive force suppression control unit 18 controls the operation of the drive device 20 so that the actual acceleration GA of the vehicle 1 becomes equal to or less than a predetermined limit acceleration G_{Lim}. By executing drive force suppression control to restrict the actual acceleration GA of the vehicle 1 to be less than or equal to the limit acceleration G_{Lim} when the driver performs an erroneous accelerator operation, it becomes possible to effectively suppress unintended rapid acceleration of the vehicle 1. Furthermore, by using the condition that the vehicle 1 is determined to be within the parking area P as an execution condition for the drive force suppression control, it is possible to effectively prevent unnecessary activation of the control on public roads or similar environments. After the drive force suppression control is initiated, when the accelerator operation amount AP decreases to equal to or less than a predetermined termination threshold value APE, the drive force suppression control unit 18 terminates the drive force suppression control (i.e., releases the limit acceleration G_{Lim}). It should be noted that such drive force suppression control can also be applied to vehicles capable of autonomous driving, particularly when transitioning from autonomous driving to manual driving by the driver.

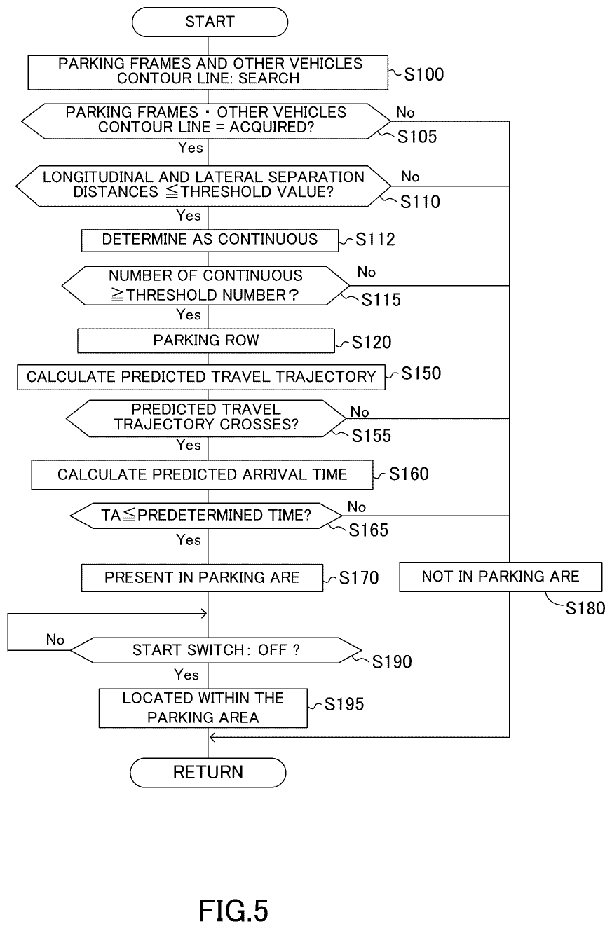

Next, a routine of a parking area determination process (hereinafter referred to as the first parking area determination process) executed by the ECU 10 in a state where the camera sensor 41 is activated will be described, based on the flowchart shown in FIG. 5.

In Step S100, the ECU 10 searches for parking spaces PL and parked vehicle contour lines VL around the vehicle 1 based on the image data captured by the camera sensor 41. Next, in Step S105, the ECU 10 determines whether at least one of the parking spaces PL or the parked vehicle contour lines VL has been successfully obtained from the image data. If the determination result is affirmative (Yes), the ECU 10 proceeds to Step S110. On the other hand, if the determination result is negative (No), the ECU 10 proceeds to Step S180, determines that the vehicle 1 is not located within the parking area P, and then returns this routine.

In Step S110, the ECU 10 determines whether the vertical and lateral separation distances between adjacent parking spaces PL or parked vehicle contour lines VL satisfy the condition that they are equal to or less than predetermined threshold values. If the condition is satisfied (Yes), the ECU 10 proceeds to Step S112, determines that the adjacent parking spaces PL or parked vehicle contour lines VL are continuous, and then advances to Step S115. Conversely, if the condition is not satisfied (No) in Step S110, the ECU 10 proceeds to Step S180, determines that the vehicle 1 is not located within the parking area P, and then returns this routine.

In Step S115, the ECU 10 determines whether the number of consecutive parking spaces PL, the number of consecutive parked vehicle contour lines VL, or the number of consecutive parking spaces PL and parked vehicle contour lines VL in any order is equal to or greater than a threshold number. If the condition is satisfied (Yes), the ECU 10 proceeds to Step S120, determines that they form a parking row PR, acquires positional information of the parking row PR, and then advances to Step S150. Conversely, if the condition is not satisfied (No) in Step S115, the ECU 10 proceeds to Step S180, determines that the vehicle 1 is not located within the parking area P, and then returns this routine.

In Step S150, the ECU 10 calculates a predicted travel trajectory of the vehicle 1. Next, in Step S155, the ECU 10 determines whether the calculated predicted travel trajectory intersects the front parking row line PR1 of the parking row PR. If an intersection is detected (Yes), the ECU 10 proceeds to Step S160. On the other hand, if no intersection is detected (No), the ECU 10 proceeds to Step S180, determines that the vehicle 1 is not located within the parking area P, and then returns this routine.

In Step S160, the ECU 10 calculates an estimated arrival time TA, which represents the time required for the vehicle 1 to reach an intersection point between the predicted travel trajectory and the front parking row line PR1 from its current position. Next, in Step S165, the ECU 10 determines whether the estimated arrival time TA is equal to or less than a predetermined time. If the estimated arrival time TA is equal to or less than the predetermined time (Yes), the ECU 10 proceeds to Step S170. Conversely, if the estimated arrival time TA is not equal to or less than the predetermined time (No), the ECU 10 proceeds to Step S180, determines that the vehicle 1 is not located within the parking area P, and then returns this routine. In Step S170, the ECU 10 determines that the vehicle 1 is located within the parking area P.

In Step S190, the ECU 10 determines whether the start switch 50 has been turned off. If the start switch 50 has not been turned off (No), the ECU 10 repeats the processing of Step S180. On the other hand, if the start switch 50 has been turned off (Yes), the ECU 10 proceeds to Step S195, stores the determination result indicating that the vehicle 1 is located within the parking area P, and then returns this routine.

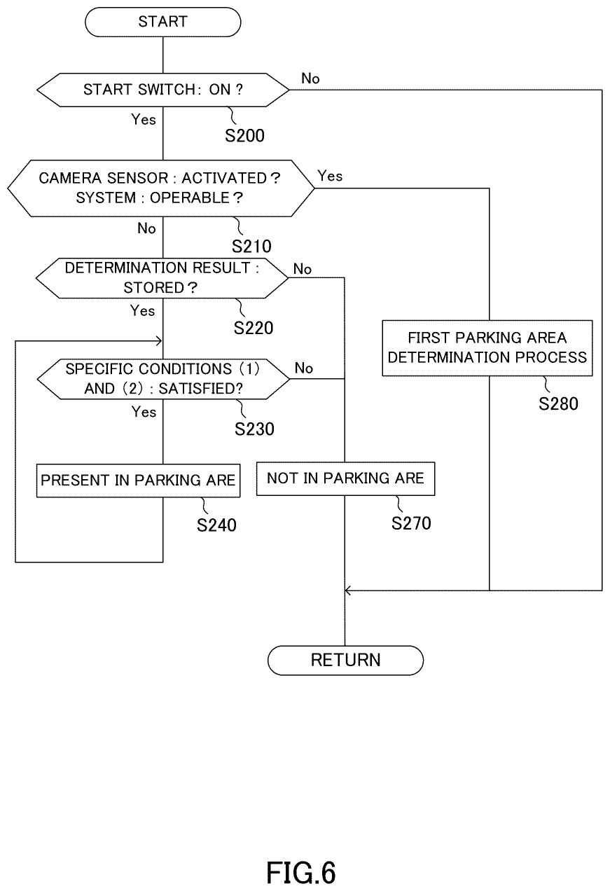

Next, a routine of a parking area determination process (hereinafter referred to as the second parking area determination process) executed by the ECU 10 immediately after the start switch 50 is turned on will be described, based on the flowchart shown in FIG. 6.

In Step S200, the ECU 10 determines whether the start switch 50 has been turned on. If the start switch 50 has been turned on (Yes), the ECU 10 proceeds to Step S210. On the other hand, if the start switch 50 has not been turned on (No), that is, if the start switch 50 is in the off state, the ECU 10 returns this routine.

In Step S210, the ECU 10 determines whether the camera sensor 41 is activated and whether the parking area determination system is in an operable state. Here, the term “the parking area determination system being in an operable state” refers to a state in which the parking space PL of the host vehicle 1 or the surrounding parking spaces PL are included within the field of view of the camera sensor 41. If the camera sensor 41 is activated and the parking area determination system is in an operable state (Yes), the ECU 10 proceeds to Step S280, and executes each of the processes corresponding to Steps S110 to S180 in the first parking area determination process shown in FIG. 5. On the other hand, if the camera sensor 41 is not activated or if the parking area determination system is not in an operable state (No), the ECU 10 proceeds to Step S220.

In Step S220, the ECU 10 determines whether, prior to the turning off of the start switch 50, the host vehicle 1 had been determined to be located within the parking area P, that is, whether a determination result indicating that the vehicle 1 is located within the parking area P has been stored. If it is determined that the vehicle 1 had previously been determined to be located within the parking area P (Yes), the ECU 10 proceeds to Step S230. Conversely, if it is determined that the vehicle 1 had not previously been determined to be located within the parking area P (No), the ECU 10 proceeds to Step S270, determines that the vehicle 1 is not located within the parking area P, and then returns this routine.

In Step S230, the ECU 10 determines whether both of the following specific conditions (1) and (2) are satisfied:
Specific condition (1): The travel distance of the vehicle 1 since the start switch 50 was turned on is less than a predetermined first threshold value.
Specific condition (2): The vehicle speed V of the vehicle 1 since the start switch 50 was turned on is less than a predetermined second threshold value.

If at least one of the specific conditions (1) or (2) is not satisfied (No), the ECU 10 proceeds to Step S270, determines that the vehicle 1 is not located within the parking area P, and then returns from the present routine. Conversely, if both specific conditions (1) and (2) are satisfied (Yes), the ECU 10 proceeds to Step S240. In Step S240, the ECU 10 determines that the vehicle 1 is located within the parking area P, and then returns to the processing of Step S230.

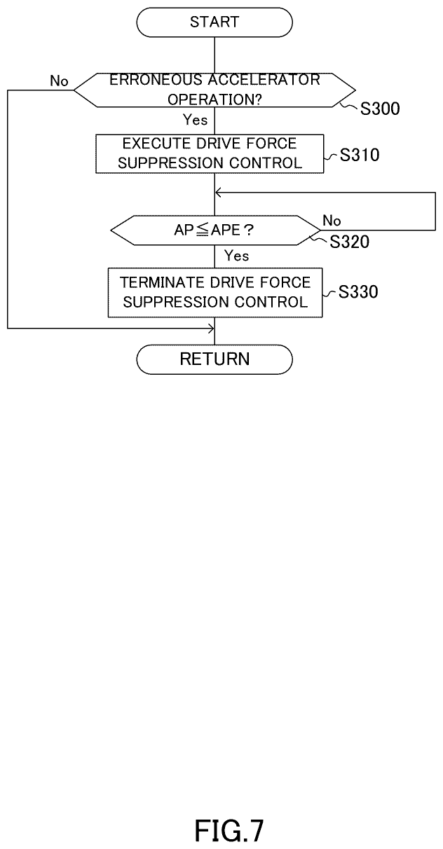

Next, a routine of erroneous accelerator operation determination and drive force suppression control processing executed by the ECU 10 will be described based on the flowchart shown in FIG. 7. This routine is initiated, for example, when the ECU 10 determines that the vehicle 1 is located within the parking area P.

In Step S300, the ECU 10 determines whether the driver has performed an erroneous accelerator operation. If all of the first to fifth determination conditions described above are satisfied (Yes), the ECU 10 determines that the driver has performed an erroneous accelerator operation, and proceeds to Step S310. On the other hand, if at least one of the first to fifth determination conditions is not satisfied (No), the ECU 10 determines that the driver has not performed an erroneous accelerator operation, and then returns this routine.

In Step S310, the ECU 10 executes drive force suppression control. Next, in Step S320, the ECU 10 determines whether the accelerator operation amount AP has decreased to equal to or less than the termination threshold value APE. If the accelerator operation amount AP has not decreased to equal to or less than the termination threshold value APE (No), the ECU 10 repeats the determination of Step S320. Conversely, if the accelerator operation amount AP has decreased to equal to or less than the termination threshold value APE (Yes), the ECU 10 proceeds to Step S330, terminates the drive force suppression control, and then returns this routine.

The parking area determination device, the vehicle control device, the parking area determination method, and the program according to the present embodiment have been described above. However, the present disclosure is not limited to the embodiment described above, and various modifications can be made without departing from the scope or spirit of the present invention.

### Modification Example 1

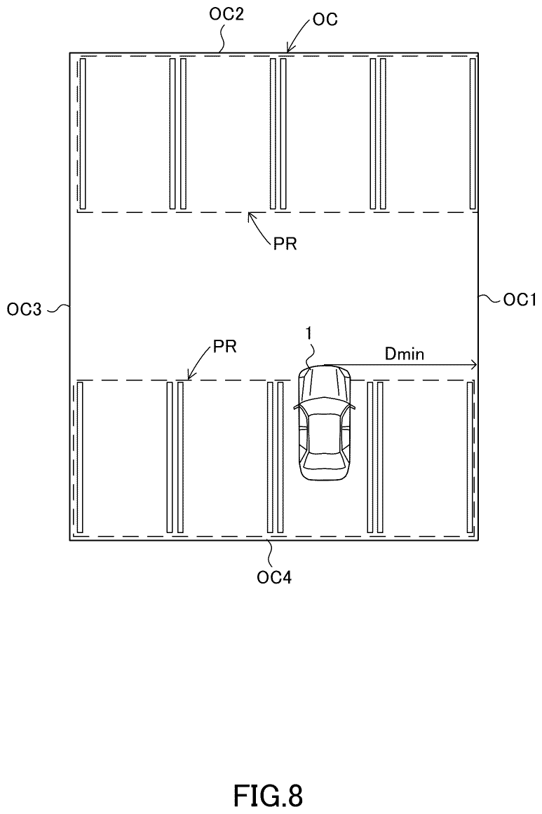

FIG. 8 is a schematic diagram illustrating Modification Example 1. In Modification Example 1, the first threshold value used in the specific condition (1) of the above embodiment is not a fixed value but a variable value. Specifically, the parking area determination unit 16 (see FIG. 1) recognizes a virtual outer perimeter OC representing the boundary of the region (site) of the parking area P having the parking rows PR, based on the parking rows PR acquired by the parking row determination unit 13, when the vehicle 1 is entering the parking area (i.e., when the start switch 50 is ON and the camera sensor 41 is activated).

In the example shown in FIG. 8, the minimum rectangular area encompassing two rows of parking rows PR serves as the virtual outer perimeter OC (OC1 to OC4). When the parking area determination unit 16 recognizes the virtual outer perimeter OC, it acquires and stores a distance Dₘᵢₙ from the front end of the vehicle 1 to the nearest virtual outer perimeter OC (OC1 in the illustrated example) immediately before completion of parking (or before the start switch 50 is turned off after parking is completed). The stored distance Dₘᵢₙ is then used as the first threshold value. That is, in Modification Example 1, during the flow of the second parking area determination process shown in FIG. 6, the first threshold value used for the determination in Step S230 is replaced with the distance Dₘᵢₙ from the front end of the vehicle 1 to the nearest virtual outer perimeter OC1.

By replacing the first threshold value at the time of departure (when the start switch 50 is turned on) with the distance Dₘᵢₙ instead of a fixed (default) value, it becomes possible to effectively prevent the following types of misjudgment:
When the first threshold value is set too short, the system might erroneously determine that the vehicle 1 is outside the parking area P even though it is actually traveling within the parking area P.

Conversely, when the first threshold value is set too long, the system might erroneously determine that the vehicle 1 is still within the parking area P even after it has already entered a public road.

Thus, by adapting the threshold dynamically according to the parking environment, appropriate recognition accuracy can be maintained. It should be noted that, although the virtual outer perimeter OC (OC1 to OC4) is described as being substantially rectangular in FIG. 8, the shape of the virtual outer perimeter is not limited thereto and may take other configurations.

### Modification Example 2

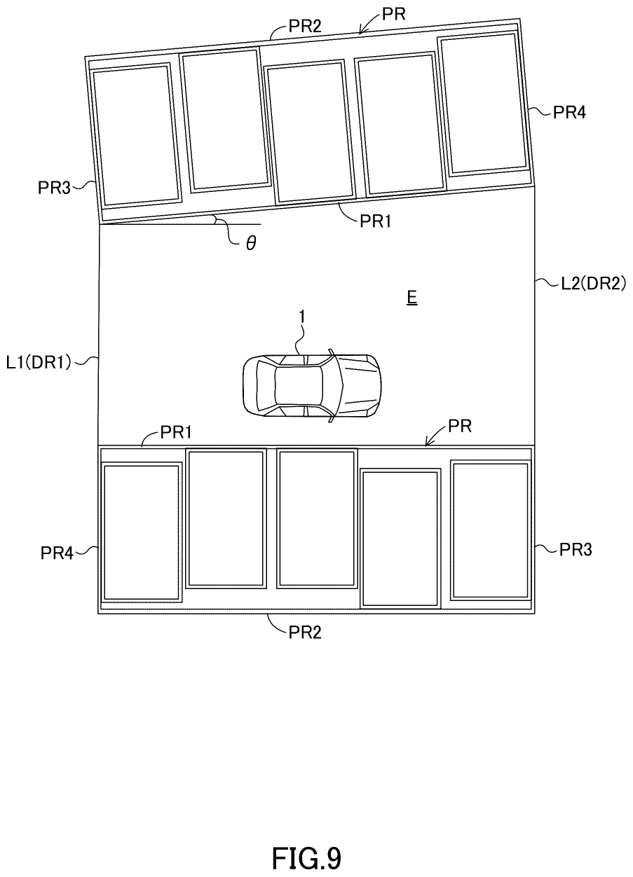

FIG. 9 is a schematic diagram illustrating Modification Example 2. In Modification Example 2, when the parking row determination unit 13 acquires a pair of parking rows PR positioned opposite each other in the longitudinal direction with the vehicle 1 located between them, the unit determines whether the region between these parking rows PR constitutes an inter-row passage. FIG. 9 is a schematic top view illustrating a pair of parking rows arranged opposite to each other with a longitudinal spacing.

The parking row determination unit 13 first calculates an angle θ formed by the longitudinal straight lines PR1 and PR2 among the straight lines PR1 to PR4 of the opposing parking rows PR (preferably, the angle formed by the front parking row line PR1). The parking row determination unit 13 also calculates the longitudinal separation distance between the opposing parking rows. Specifically, the unit calculates distances DR1 and DR2 as the lengths of straight lines L1 and L2 that connect the respective end portions of the opposing front parking row lines PR1, that is, the straight lines connecting the opposing corner portions of each parking row PR.

When the calculated angle θ is equal to or less than a predetermined threshold angle θV, and both of the calculated separation distances DR1 and DR2 are equal to or less than a predetermined distance threshold DRV, the parking row determination unit 13 determines that the region E, which is enclosed by the opposing front parking row lines PR1 and the straight lines connecting their end portions, constitutes an inter-row passage. Here, the threshold angle θV is not particularly limited, but it may be set based on an angle at which the opposing front parking row lines PR1 can be regarded as being substantially parallel for example, 10° or less.

In Modification Example 2, when the parking area determination unit 16 determines, based on the judgment of the parking row determination unit 13, that the region between the parking rows PR is an inter-row passage, and when the vehicle 1 is located within the region E, the parking area determination unit 16 determines that the vehicle 1 is located within the parking area P. Thus, by determining that the vehicle 1 is located within the parking area P when it is positioned within the region E between a pair of opposing parking rows PR, it becomes possible to effectively activate the drive force suppression control, even in cases such as in large commercial parking lots where parking rows are provided on both sides of a lane R and the predicted travel trajectory does not intersect the front parking row line PR1.

What is claimed is:

1. A parking area determination device comprising:
a parking row acquisition unit configured to detect, based on image data acquired by an in-vehicle imaging device that captures surroundings of a vehicle, parking spaces and/or parked vehicles around the vehicle, and to acquire parking rows in which the detected parking spaces and/or parked vehicles are adjacent to each other in a predetermined direction and appear continuously in a number equal to or greater than a predetermined threshold; and
a parking area determination unit configured to determine whether the vehicle is located within a parking area having the parking rows,
wherein the parking area determination unit:
after determining that the vehicle is located within the parking area, when a first condition is satisfied in which a start switch of the vehicle is turned off, and when a second condition is satisfied in which, upon the start switch being turned on, the in-vehicle imaging device has not yet been activated,
determines that the vehicle is located within the parking area while specific conditions are satisfied in which a travel distance of the vehicle from establishment of the second condition is less than a predetermined first threshold, and a vehicle speed is less than a predetermined second threshold,
and determines that the vehicle is not located within the parking area when the specific conditions are no longer satisfied.

2. The parking area determination device according to claim 1,
wherein the parking area determination unit:
acquires a region of the parking area having the parking rows based on information of the parking rows acquired by the parking row acquisition unit,
acquires a shortest distance from the vehicle to an outer perimeter of the region based on a relative position between the vehicle and the region,
and sets the acquired shortest distance as the first threshold.

3. A vehicle control device comprising the parking area determination device according to claim 1,
the vehicle control device comprising:
an erroneous operation determination unit configured to acquire an operation state of an acceleration operation member operated by an occupant to accelerate the vehicle, and to determine, based on the operation state, whether the occupant has erroneously depressed the acceleration operation member; and
a control unit configured to execute drive force suppression control for suppressing a drive force of the vehicle when the parking area determination unit determines that the vehicle is located within the parking area and the erroneous operation determination unit determines that an erroneous operation has been performed by the occupant.

4. A parking area determination method comprising:
detecting, based on image data acquired by an in-vehicle imaging device that captures surroundings of a vehicle, parking spaces and/or parked vehicles around the vehicle;
acquiring parking rows in which the detected parking spaces and/or parked vehicles are adjacent to each other in a predetermined direction and appear continuously in a number equal to or greater than a predetermined threshold; and
determining whether the vehicle is located within a parking area having the parking rows,
wherein, after determining that the vehicle is located within the parking area, when a first condition is satisfied in which a start switch of the vehicle is turned off, and when a second condition is satisfied in which, upon the start switch being turned on, the in-vehicle imaging device has not yet been activated,
the method includes determining that the vehicle is located within the parking area while specific conditions are satisfied in which a travel distance of the vehicle from establishment of the second condition is less than a predetermined first threshold and a vehicle speed is less than a predetermined second threshold,
and determining that the vehicle is not located within the parking area when the specific conditions are no longer satisfied.

5. A program for causing a computer of a parking area determination device,
wherein the parking area determination device comprises:
a parking row acquisition unit configured to detect, based on image data acquired by an in-vehicle imaging device that captures surroundings of a vehicle, parking spaces and/or parked vehicles around the vehicle, and to acquire parking rows in which the detected parking spaces and/or parked vehicles are adjacent to each other in a predetermined direction and appear continuously in a number equal to or greater than a predetermined threshold;
and a parking area determination unit configured to determine whether the vehicle is located within a parking area having the parking rows,
wherein the program is configured to execute processing such that, after determining that the vehicle is located within the parking area, when a first condition is satisfied in which a start switch of the vehicle is turned off, and when a second condition is satisfied in which, upon the start switch being turned on, the in-vehicle imaging device has not yet been activated,
the vehicle is determined to be located within the parking area while specific conditions are satisfied in which a travel distance of the vehicle from establishment of the second condition is less than a predetermined first threshold and a vehicle speed is less than a predetermined second threshold, and the vehicle is determined to be not located within the parking area when the specific conditions are no longer satisfied.
